(19) United States
(12) Patent Application Publication
(10) Pub. No.: US 2026/0045990 A1
(43) Pub. Date: Feb. 12, 2026

(54) CAPABILITY FOR LOGICAL RESOURCE FOR BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Chenxi HAO, Beijing (CN)

(21) Appl. No.: 19/099,305

(22) PCT Filed: Sep. 28, 2022
(86) PCT No.: PCT/CN2022/121990

§ 371 Date: Jan. 28, 2025

(51) Int. Cl. H04B 7/06; H04W 24/10

(52) U.S. Cl. CPC H04B 7/0626; H04B 7/06952; H04W 24/10

(57) ABSTRACT

Various aspects of the present disclosure generally relate to wireless communication. In some aspects, a user equipment (UE) may transmit capability information indicating a capability associated with first measurement resources, the first measurement resources comprising logical resources for beam management and on which reference signaling is, at least partially, untransmitted or unmonitored. The UE may transmit a channel state information (CSI) report based at least in part on the capability. Numerous other aspects are described.

### FIELD OF THE DISCLOSURE

Aspects of the present disclosure generally relate to wireless communication and to techniques and apparatuses for a capability for logical resources for beam management.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include transmitting capability information indicating a capability associated with first measurement resources, the first measurement resources comprising logical resources for beam management and on which reference signaling is, at least partially, unmonitored. The method may include transmitting a channel state information (CSI) report based at least in part on the capability.

Some aspects described herein relate to a method of wireless communication performed by a network node. The method may include obtaining, from a UE, capability information indicating a capability associated with first measurement resources, the first measurement resources comprising logical resources for beam management and on which reference signaling is, at least partially, untransmitted. The method may include outputting configuration information configuring one or more first measurement resources in accordance with the capability.

Some aspects described herein relate to a UE for wireless communication. The UE may include a memory and one or more processors coupled to the memory. The one or more processors may be configured to transmit capability information indicating a capability associated with first measurement resources, the first measurement resources comprising logical resources for beam management and on which reference signaling is, at least partially, unmonitored. The one or more processors may be configured to transmit a CSI report based at least in part on the capability.

Some aspects described herein relate to a network node for wireless communication. The network node may include a memory and one or more processors coupled to the memory. The one or more processors may be configured to obtain, from a UE, capability information indicating a capability associated with first measurement resources, the first measurement resources comprising logical resources for beam management and on which reference signaling is, at least partially, untransmitted. The one or more processors may be configured to output configuration information configuring one or more first measurement resources in accordance with the capability.

Some aspects described herein relate to a non-transitory computer-readable medium that stores a set of instructions for wireless communication by a UE. The set of instructions, when executed by one or more processors of the UE, may cause the UE to transmit capability information indicating a capability associated with first measurement resources, the first measurement resources comprising logical resources for beam management and on which reference signaling is, at least partially, unmonitored. The set of instructions, when executed by one or more processors of the UE, may cause the UE to transmit a CSI report based at least in part on the capability.

Some aspects described herein relate to a non-transitory computer-readable medium that stores a set of instructions for wireless communication by a network node. The set of instructions, when executed by one or more processors of the network node, may cause the network node to obtain, from a UE, capability information indicating a capability associated with first measurement resources, the first measurement resources comprising logical resources for beam management and on which reference signaling is, at least partially, untransmitted. The set of instructions, when executed by one or more processors of the network node, may cause the network node to output configuration information configuring one or more first measurement resources in accordance with the capability.

Some aspects described herein relate to an apparatus for wireless communication. The apparatus may include means for transmitting capability information indicating a capability associated with first measurement resources, the first measurement resources comprising logical resources for beam management and on which reference signaling is, at least partially, unmonitored. The apparatus may include means for transmitting a CSI report based at least in part on the capability.

Some aspects described herein relate to an apparatus for wireless communication. The apparatus may include means for obtaining, from a UE, capability information indicating a capability associated with first measurement resources, the first measurement resources comprising logical resources for beam management and on which reference signaling is, at least partially, untransmitted. The apparatus may include means for outputting configuration information configuring one or more first measurement resources in accordance with the capability.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of an artificial intelligence and/or machine learning (AI/ML) based beam management, in accordance with the present disclosure.

FIG. 7 is a diagram illustrating examples of actual measurement resources and virtual measurement resources, in accordance with the present disclosure.

FIG. 8 is a diagram illustrating an example of signaling for a capability regarding a virtual measurement resource, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

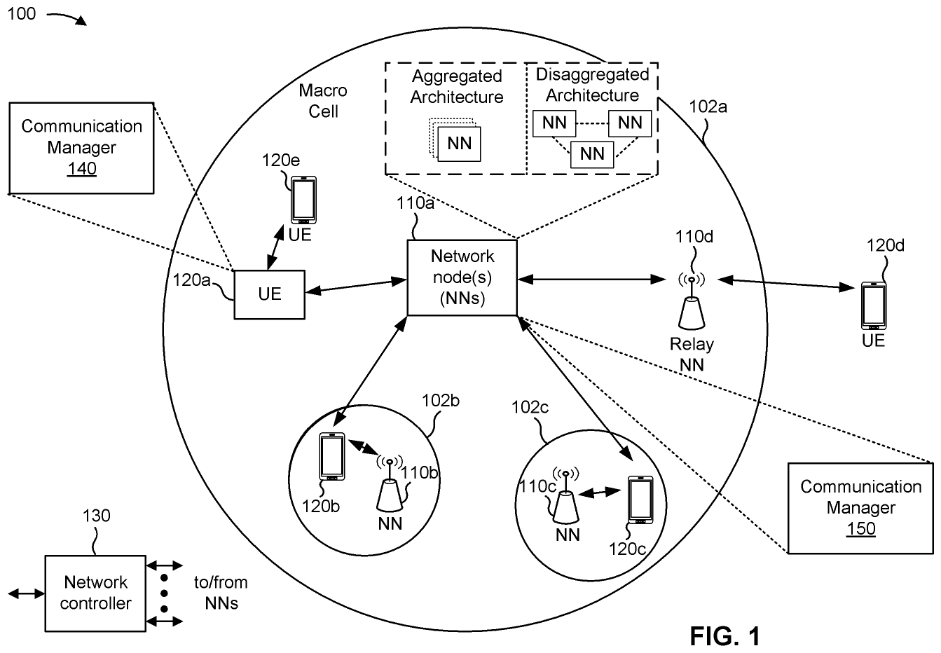

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IOT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel.

Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit capability information indicating a capability associated with first measurement resources, the first measurement resources comprising logical resources for beam management and on which reference signaling is, at least partially, unmonitored; and transmit a channel state information (CSI) report based at least in part on the capability. Additionally, or alternatively, the communication manager 140 may perform one or more other operations described herein.

In some aspects, the network node 110 may include a communication manager 150. As described in more detail elsewhere herein, the communication manager 150 may obtain, from a UE, capability information indicating a capability associated with first measurement resources, the first measurement resources comprising logical resources for beam management and on which reference signaling is, at least partially, untransmitted; and output configuration information configuring one or more first measurement resources in accordance with the capability. Additionally, or alternatively, the communication manager 150 may perform one or more other operations described herein.

As indicated above, FIG. 1 is provided as an example. Other examples may differ from what is described with regard to FIG. 1.

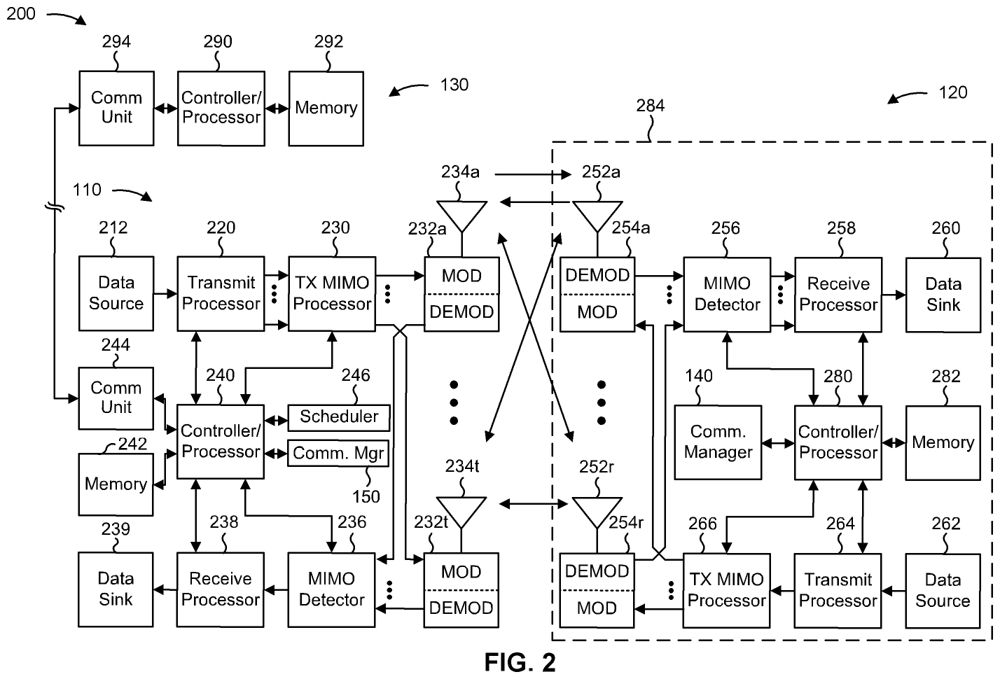

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

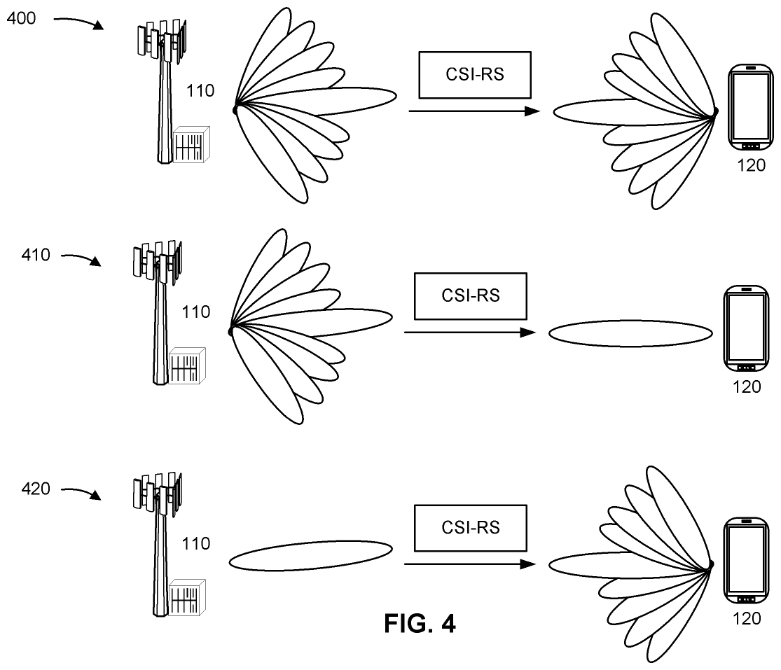

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-12).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

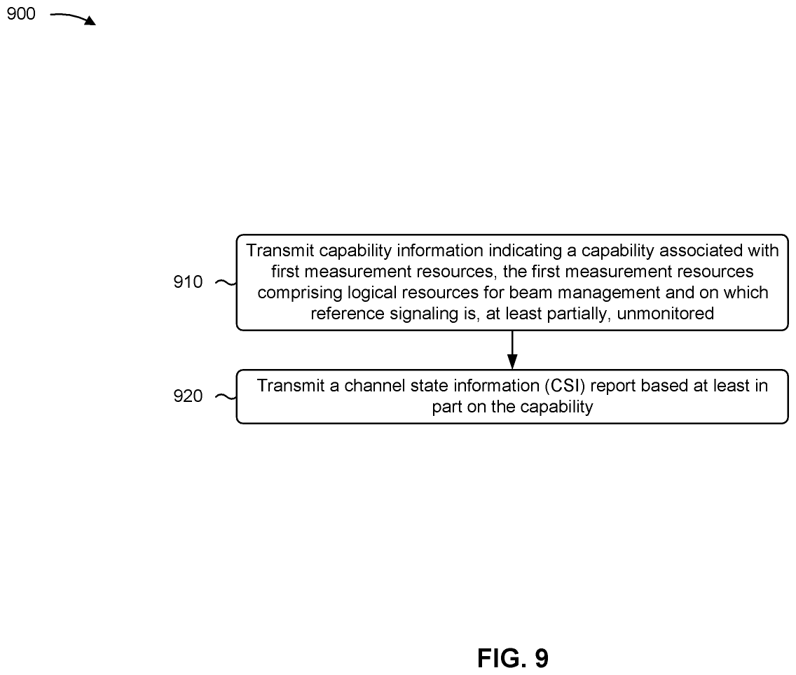

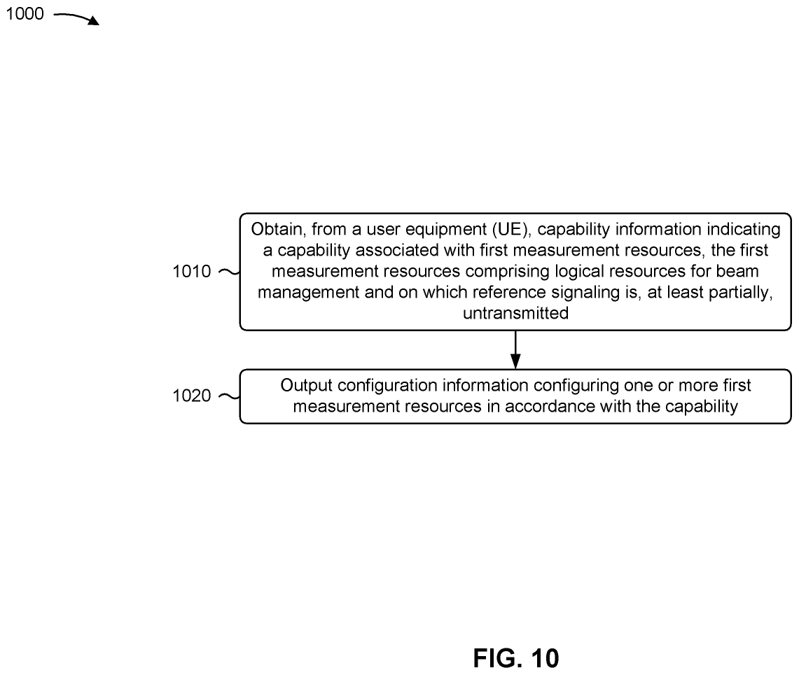

The controller/processor 240 of the network node 110, the controller/processor 280 of the UE 120, or any other component(s) of FIG. 2 may perform one or more techniques associated with CSI reporting with virtual measurement resources, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE includes means for transmitting capability information indicating a capability associated with first measurement resources, the first measurement resources comprising logical resources for beam management and on which reference signaling is, at least partially, unmonitored; and/or means for transmitting a CSI report based at least in part on the capability. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for obtaining, from a user UE, capability information indicating a capability associated with first measurement resources, the first measurement resources comprising logical resources for beam management and on which reference signaling is, at least partially, untransmitted; and/or means for outputting configuration information configuring one or more first measurement resources in accordance with the capability. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

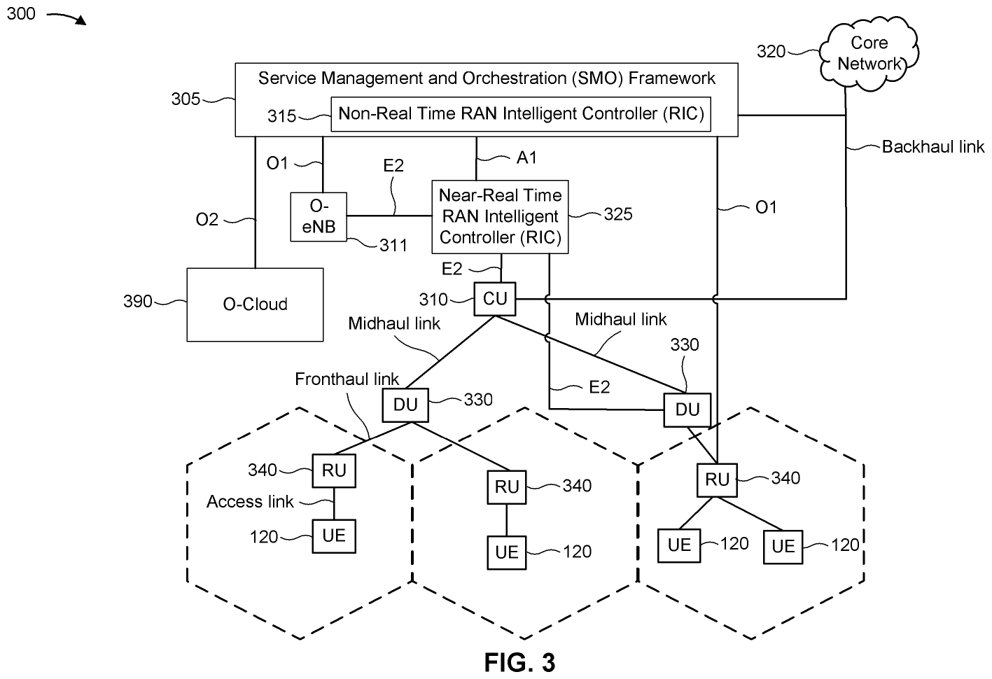

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate artificial intelligence (AI) and/or machine learning (ML) (AI/ML) models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of beam management procedures, in accordance with the present disclosure. As shown in FIG. 4, examples 400, 410, and 420 include a UE 120 in communication with a network entity (e.g., network node 110) in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. Generally, beam management includes performing measurements (e.g., Layer 1 measurements) on one or more reference signals using one or more beams for the purpose of selecting or refining a cell or a beam. Beam management can include a variety of different procedures, such as beam selection, beam acquisition, beam sweeping, beam search, beam refinement, cell search, and so on. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC CE) signaling), and/or aperiodic (e.g., using downlink control information (DCI)).

The first beam management procedure may include the network node 110 performing beam sweeping over multiple transmit (Tx) beams. “Beam sweeping” refers to transmitting a reference signal (e.g., a same reference signal), or receiving (e.g., measuring) the reference signal, on each of multiple different beams, which may be distributed spatially across one or more directions. For example, the network node 110 may transmit a CSI-RS using each of the multiple transmit beams for beam management. To enable the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of one or more beam pairs including a network node 110 transmit beam and a UE 120 receive beam. The UE 120 may report the measurements to the network node 110 to enable the network node 110 to select one or more beam pairs for communication between the network node 110 and the UE 120. While example 400 has been described in connection with CSI-RSs, the first beam management process may also use synchronization signal blocks (SSBs) or other forms of reference signal for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management).

The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. Thus, beam refinement may include measuring CSI-RSs on one or more transmit beams, that are selected based on measurements reported by the UE 120, using a single receive beam of the UE 120. In some examples, the one or more transmit beams may be more granular than the N transmit beams of the first beam management procedure (e.g., may have a narrower spatial separation from one another than the N transmit beams). The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). Thus, beam refinement may also or alternatively include measuring CSI-RSs on a single transmit beam, using a set of receive beams of the UE 120. The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

A CSI-RS is transmitted and received (e.g., measured) on a CSI-RS resource. A CSI-RS resource is configured by a network node 110 for a UE 120 using various configuration parameters described elsewhere herein. A CSI-RS can be a zero-power (ZP) CSI-RS (ZP-CSI-RS) or a non-ZP CSI-RS (NZP-CSI-RS). An NZP-CSI-RS is a CSI-RS that is actually transmitted. For example, an NZP-CSI-RS may be transmitted on an NZP-CSI-RS resource. A ZP-CSI-RS is configured via a ZP-CSI-RS resource, and is not actually transmitted. For example, a network node 110 may configure a ZP-CSI-RS resource, and may not transmit a CSI-RS on the configured resource. NZP-CSI-RSs can be used as a channel measurement resource (CMR) for determination of a CSI or a Layer 1 report, such as for beam management (e.g., for L1 RSRP or L1 signal to interference plus noise (SINR) measurement and reporting), where a CMR is a resource used to determine a channel measurement such as a CSI measurement or a Layer 1 measurement. NZP-CSI-RSs can also be used for tracking (e.g., frequency tracking and/or time tracking) as a tracking reference signal (TRS). For example, a TRS may be implemented as a single-port CSI-RS. A ZP-CSI-RS may be used for rate matching.

Transmission and configuration of an NZP-CSI-RS (or the relevant resource), or configuration of a ZP-CSI-RS resource, can be periodic (in which a CSI-RS resource is configured with a periodicity and recurs until de-configured), semi-persistent (in which a CSI-RS resource is configured with a periodicity and, once activated, recurs until the configuration of the CSI-RS resource released), or aperiodic (in which a CSI-RS is triggered by signaling and/or a configured triggering state).

A CSI-RS may be configured with a CSI-RS pattern which may indicate, among other information, a number of ports on which the CSI-RS is transmitted (e.g., 1, 2, 3, 8, 12, 16, 24, or 32 ports, among other examples). The number of ports may correspond to a number of resource elements (REs) of a resource block on which the CSI-RS is transmitted.

An NZP-CSI-RS resource, or signaling, may identify a quasi co-location (QCL) parameter and a QCL source of the NZP-CSI-RS to be transmitted or measured on the NZP-CSI-RS resource. The QCL parameter may identify one or more parameters (e.g., a spatial parameter or another form of parameter) to be derived from the QCL source. The QCL source may include, for example, an SSB or another CSI-RS. In some aspects, a transmission configuration indication (TCI) state may identify the QCL parameter and the QCL source, where a TCI state is information identifying a QCL parameter and a QCL source. For a periodic NZP-CSI-RS, the QCL parameter and/or source may be configured via an RRC configuration of the periodic NZP-CSI-RS's resource. For a semi-persistent NZP-CSI-RS, the QCL parameter and/or source may be configured via an activation command (e.g., a MAC-CE activation command) that activates the configured NZP-CSI-RS resource of the semi-persistent NZP-CSI-RS. For an aperiodic NZP-CSI-RS, the QCL parameter and/or source may be configured by the NZP-CSI-RS's triggering state configuration, and may be indicated via DCI indicating an uplink grant associated with the NZP-CS-RS.

A UE 120 may have various capabilities regarding CSI-RS signaling or measurement. As one example, a UE may have a capability regarding a maximum number of configured or activated CSI-RS resources or ports. For example, in any slot, the UE may not be expected to have more active CSI-RS ports or active CSI-RS resources in active bandwidth parts (BWPs) (where a BWP is a configured set of resource blocks that can be activated or deactivated for active communication via dynamic signaling) than a maximum number of CSI-RS ports or resources that the UE has reported via capability information. An aperiodic NZP-CSI-RS resource may be active starting from an end of a physical downlink control channel (PDCCH) containing a request for the CSI-RS and ending at the end of a scheduled physical uplink shared channel (PUSCH) containing the report associated with this aperiodic CSI-RS. A semi-persistent CSI-RS may be active starting from an end of when the activation command is applied, and ending at an end of when the deactivation command is applied. A periodic CSI-RS may be active starting when the periodic CSI-RS is configured by higher layer signaling, and ending when the periodic CSI-RS configuration is released. If a CSI-RS resource is referred to N times by one or more CSI reporting settings, the CSI-RS resource and the CSI-RS ports within the CSI-RS resource are counted N times for the purpose of determining a number of active resources. A CSI reporting setting indicates a configuration for reporting CSI derived from a CSI-RS resource referred to by the CSI reporting setting.

A UE may signal a capability via capability information. The capability information may include various parameters indicating various capabilities. A parameter indicating a capability may be identified by a parameter name. Examples of parameter names and corresponding capabilities are provided below.

In some aspects, a capability may relate to a case where a UE is not configured to provide information regarding an L1 RSRP or an L1 SINR in a corresponding CSI report. In such aspects, a csi-RS-IM-ReceptionForFeedback parameter may indicate whether a UE supports CSI-RS and CSI-RS for interference management (CSI-IM) reception for CSI feedback. The csi-RS-IM-ReceptionForFeedback parameter may include the following parameters: maxConfigNumberNZP-CSI-RS-PerCC, which indicates a maximum number of configured NZP-CSI-RS resources per component carrier (CC), where a CC is a configured bandwidth that can be activated and deactivated for data and/or control communication of the UE via RRC signaling; maxConfigNumberPortsAcrossNZP-CSI-RS-PerCC, which indicates the maximum number of ports across all configured NZP-CSI-RS resources per CC; maxConfigNumberCSI-IM-PerCC, which indicates the maximum number of configured CSI-IM resources per CC; maxNumberSimultaneousNZP-CSI-RS-PerCC, which indicates the maximum number of simultaneous CSI-RS-resources per CC; and totalNumberPortsSimultaneousNZP-CSI-RS-PerCC, which indicates the total number of CSI-RS ports in simultaneous CSI-RS resources per CC.

In some other aspects, a capability may relate to a case where a UE can be configured to provide information regarding an L1 RSRP or an L1 SINR in a corresponding CSI report. As one example, a maxTotalResourcesForOneFreqRange parameter may indicate a maximum total number of SSB, CSI-RS, and CSI-IM resources configured to measure within a slot across all CCs in one frequency range for any of L1-RSRP measurement, L1-SINR measurement, pathloss measurement, beam failure detection (BFD), radio link monitoring (RLM), or new beam identification. A maxNumber ResWithinSlotAcrossCC-OneFR parameter may indicate a maximum total number of SSB, CSI-RS, and CSI-IM resources configured to measure within a slot across all CCs in one frequency range for any of L1-RSRP measurement, L1-SINR measurement, pathloss measurement, BFD, RLM, or new beam identification. A maxNumberResAcrossCC-OneFR parameter may indicate a maximum total number of SSB, CSI-RS, and CSI-IM resources configured across all CCs in one frequency range for any of L1-RSRP measurement, L1-SINR measurement, pathloss measurement, BFD, RLM, or new beam identification. As another example, a max TotalResourcesFor AcrossFreqRanges parameter may indicate a maximum total number of SSB, CSI-RS, and CSI-IM resources configured to measure within a slot across all frequency ranges for any of L1-RSRP measurement, L1-SINR measurement, pathloss measurement, BFD, RLM, or new beam identification. A maxNumber ResWithinSlotAcrossCC-AcrossFR parameter may indicate a maximum total number of SSB, CSI-RS, and CSI-IM resources that can be configured to measure within a slot across all frequency ranges for any of L1-RSRP measurement, L1-SINR measurement, pathloss measurement, BFD, RLM, or new beam identification. A maxNumberResAcrossCC-AcrossFR parameter may indicate a maximum total number of SSB, CSI-RS, and CSI-IM resources that can be configured across all frequency ranges for any of L1-RSRP measurement, L1-SINR measurement, pathloss measurement, BFD, RLM, or new beam identification.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

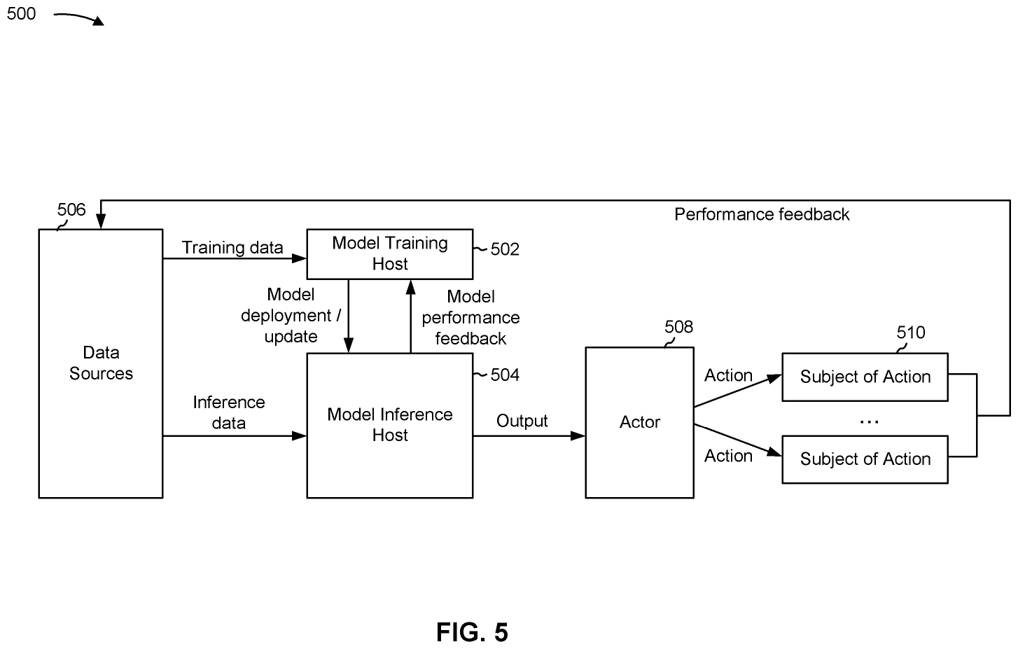

FIG. 5 is a diagram illustrating an example architecture 500 of a functional framework for RAN intelligence enabled by data collection, in accordance with the present disclosure. In some scenarios, the functional framework for RAN intelligence may be enabled by enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) using the inference data input to the actor 508. The actor 508 may be an element or an entity of a core network or a RAN. For example, the actor 508 may be a UE, a network node, a network entity, a base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU. As another example, if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change or modify a Tx/Rx beam based on the output. If the actor 508 determines to act based on the output, the actor 508 may indicate the action to at least one subject associated with action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify the actor 508's Tx/Rx beam based on the beam (re-)configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110 based on the one or more predicted measurement values. For example, if the one or more predicted measurement values satisfy a threshold (such as a threshold relative to an actual measurement value, a measurement reporting threshold, or another form of threshold), the actor 508 may determine that a measurement report is to be transmitted to the network node 110 indicating the one or more predicted measurement values and/or the actual measurement value.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

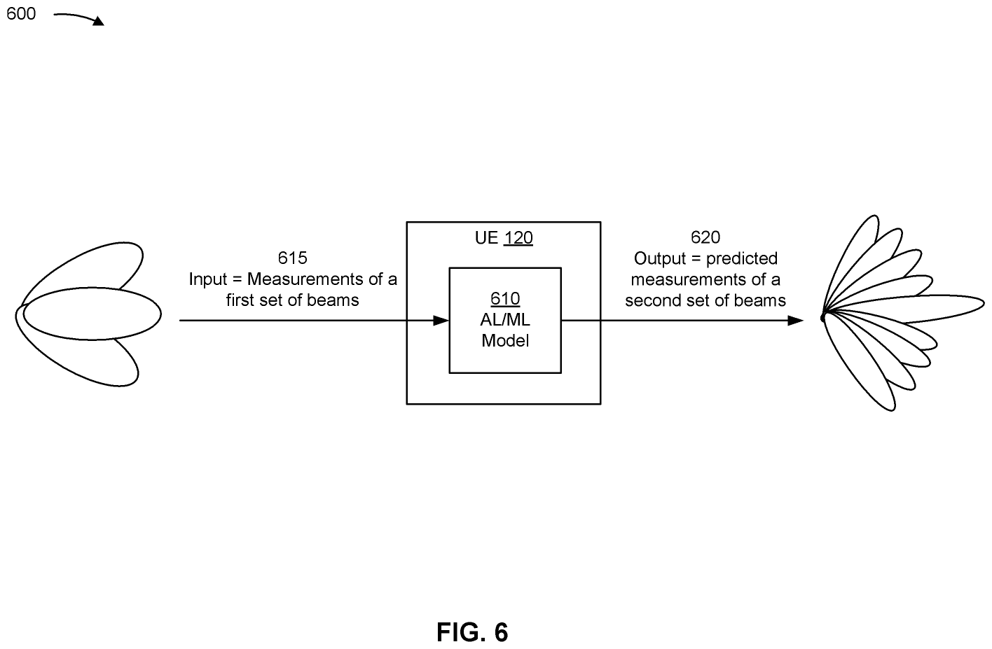

FIG. 6 is a diagram illustrating an example 600 of an AI/ML based beam management, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. A measurement may be associated with a beam if the measurement is a measurement of a reference signal that is transmitted using the beam (where the beam is a transmit beam) or if the measurement is a measurement of a reference signal using the beam (where the beam is a receive beam). For example, a network node 110 may transmit one or more signals via respective beams from the first set of beams. The UE 120 may perform measurements (e.g., L1 RSRP measurements, L1 SINR measurements, or other measurements) of the first set of beams to obtain a first set of measurement values. For example, each beam, from the first set of beams, may be associated with one or more measurements performed by the UE 120. The UE 120 may input the first set of measurement values (e.g., L1 RSRP measurement values) into the AI/ML model 610 along with information regarding the first set of beams and/or a second set of beams, such as a beam direction (e.g., spatial direction), beam width, beam shape, and/or other characteristics of the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conserving power of the UE 120 and/or network resources that would have otherwise been used to transmit or measure all beams included in the first set of beams and the second set of beams. This type of prediction may be referred to as a codebook based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement reports or values, collected at different points in time (e.g., time domain information regarding measurement reports or values), may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality (e.g., as represented by a predicted CQI or precoding matrix indicator (PMI)) or interference adaptation procedure, beam failure and/or beam blockage predictions, and/or radio link failure predictions, among other examples. This may lead to better management accuracy without excessive beam sweeping.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

In some aspects, there may be connections between resources for predictive beam management. For example, the UE 120 may receive an indication of a first set of resources and a second set of resources and an indication of one or more connections between the first set of resources and the second set of resources. The one or more connections may include a connection associated with a resource, included in the first set of resources or the second set of resources, that is defined with respect to one or more resources included in a different set of resources from the first set of resources or the second set of resources. In other words, the connections may be implicit connections defining beam characteristics associated with a given resource with respect to beams associated with other resources(s) that are included in a different set. In some examples, the connection described herein may be referred to as an implicit connection, an association, a relation, a relationship, a correspondence, a mapping, and/or a link, among other examples. The connection may indicate a relationship between a first spatial direction or a first beam associated with the resource and one or more second spatial directions or second beams of the one or more resources included in the different set of resources. The second set of resources may be channel measurement resources for a CSI report and the first set of resources may be resources that are not to be actually measured by the UE 120 (e.g., virtual resources, sometimes referred to as nominal resources). For example, the second set of resources may be associated with Set B beams and the first set of resources may be associated with Set A beams. In some aspects, the connections may be graph-based connections or may be linear combinations.

The UE 120 may transmit a CSI report indicating measurement values associated with the first set of resources and the second set of resources. A first one or more measurement values, from the measurement values, associated with the first set of resources may be measured by the UE 120. A second one or more measurement values, from the measurement values, associated with the second set of resources may be predicted by the UE 120 based at least in part on the first one or more measurement values and the one or more connections. In other words, the UE 120 may use the connections between the first set of resources and the second set of resources to obtain beam characteristics or beam shapes associated with the first set of resources and the second set of resources. The UE 120 may use the beam characteristics or beam shapes associated with the first set of resources and the second set of resources to perform one or more AI/ML predictions associated with the first set of resources and the second set of resources.

In some aspects, one or more resources included in the second set of resources may be used for a TCI state indication. Additionally, or alternatively, one or more resources included in the second set of resources may be used by the UE 120 as a source reference for a QCL source (e.g., even though the UE 120 has not actually received and/or measured signal(s) via the second set of resources).

As a result, the UE 120 may be enabled to perform improved predictive beam management by obtaining beam characteristics (e.g., beam shape and/or beam width) associated with the first set of resources and the second set of resources. Additionally, by using implicit connections between two sets of resources, the UE 120 and/or a network node 110 may conserve a signaling overhead, network resources, processing resources, and/or power associated with indicating the beam characteristics (e.g., beam shape and/or beam width) associated with the first set of resources and the second set of resources. For example, by using implicit connections between the two sets of resources, detailed beamforming information or implementations performed at a network node 110 do not need to be disclosed or indicated to the UE 120.

As indicated above, FIG. 6 is provided as an example. Other examples may differ from what is described with regard to FIG. 6.

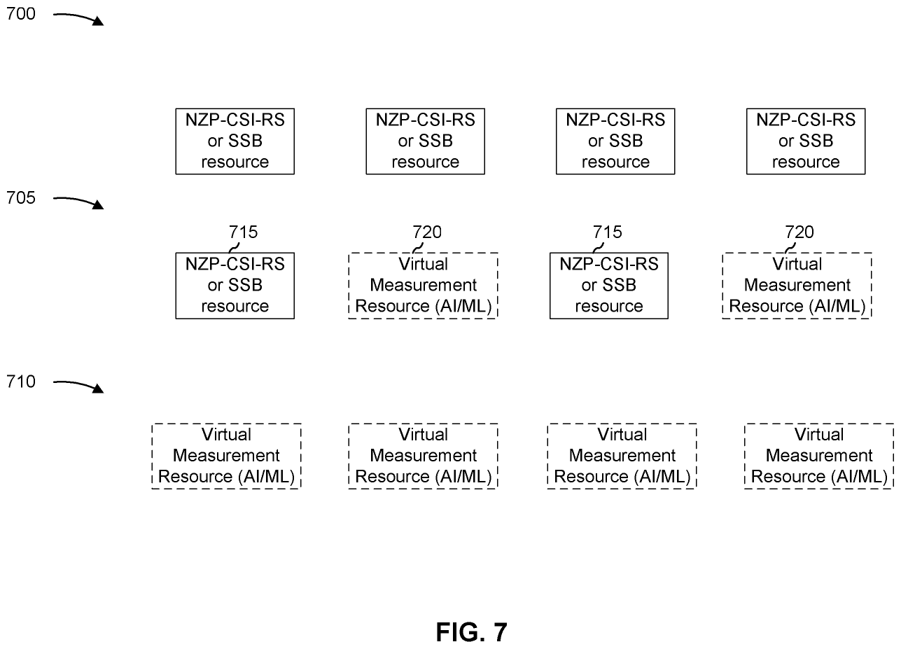

FIG. 7 is a diagram illustrating examples 700, 705, and 710 of actual measurement resources and virtual measurement resources, in accordance with the present disclosure. In some aspects, a virtual measurement resource may be referred to as a first measurement resource, and an actual measurement resource may be referred to as a second measurement resource.

A virtual measurement resource is a logical resource for beam management. A logical resource can include a configured resource or a resource indicated by dynamic signaling. A logical resource may be for beam management if the logical resource, or a reference signal transmitted on the logical resource, is used for beam management, as described, for example, with regard to FIGS. 4-6.

Example 700 is an example of an actual measurement resource. An actual measurement resource may include a resource in which reference signaling is transmitted, such as an NZP-CSI-RS resource, a ZP-CSI-RS resource, a CSI-IM resource, or an SSB resource. While a UE typically does not perform a measurement on a ZP-CSI-RS resource, a ZP-CSI-RS resource may be considered an actual measurement resource since a CSI-RS is typically transmitted on a ZP-CSI-RS resource (even if a UE configured with a ZP-CSI-RS resource does not measure the CSI-RS). In contrast, in some aspects, reference signaling may not be transmitted on a virtual measurement resource. In some aspects, an actual measurement resource may include a resource in which reference signaling is received (e.g., measured) by the UE 120. A network node 110 may transmit a reference signal on an actual measurement resource using a Set B beam, as described with regard to FIG. 6. In example 700, the actual measurement resource is a periodic or semi-persistent measurement resource including a number of occasions. In some aspects, the measurement performed by the UE on an actual measurement resource may include a channel measurement, such as may be used to determine CSI.

Examples 705 and 710 are examples of virtual measurement resources. In some aspects, a virtual measurement resource may include a measurement resource in which reference signaling is at least partially untransmitted by the network node 110. In some aspects, a virtual measurement resource may include a measurement resource in which reference signaling is at least partially unmonitored (e.g., unmeasured, unreceived, unused) by the UE 120. A virtual measurement resource may include a measurement resource for which a UE uses an AI/ML model (described with regard to FIG. 6) to predict a measurement value (or a value derived from a measurement value) that would be derived from a measurement of reference signaling transmitted in the virtual measurement resource. For example, the measurement value may include a CSI value (e.g., one or more parameters that can be included in a CSI report). In some aspects, the measurement value determined using the AI/ML model for a virtual measurement resource may include a channel measurement, such as may be used to determine CSI. A virtual measurement resource can comprise a channel measurement resource (that is, a resource on which a UE computes a prediction of a channel measurement), an interference measurement resource (IMR) (that is, a resource on which a UE computes a prediction of an interference measurement), or a combination thereof.

Example 705 shows a first example of a virtual measurement resource, referred to as a Type-1 virtual measurement resource. A Type-1 virtual measurement resource is a resource in which reference signaling is partially untransmitted and/or unmonitored (in other words, reference signaling is transmitted on some occasions of a Type-1 virtual measurement resource and not in other occasions of the Type-1 virtual measurement resource). For example, a virtual measurement resource may include a resource on which reference signaling is not transmitted and another measurement resource on which reference signaling is transmitted. For Type-1 virtual measurement resources, a first subset of occasions 715 (e.g., time-domain occasions) of the virtual measurement resources are used to transmit reference signaling, and a second subset of occasions 720 (e.g., time-domain occasions) of the virtual measurement resources are untransmitted and/or unmonitored (e.g., are not used to transmit reference signaling, or are not measured or monitored by the UE). Type-1 virtual measurement resources may be beneficial because the UE can compare actual measurement values derived from the first subset of occasions 715 to predicted measurement values associated with the second subset of occasions 720 to evaluate accuracy of outputs of, and/or train, the AI/ML model. A Type-1 virtual measurement resource may include one or more NZP-CSI-RS resources or SSB resources in the first subset of occasions 715. In some aspects, a Type-1 virtual measurement resource may be connected with an actual measurement resource, as described in connection with FIG. 6.

Example 710 shows a second example of a virtual measurement resource, referred to as a Type-2 virtual measurement resource. For Type-2 virtual measurement resources, all occasions of the virtual measurement resource are untransmitted and/or unmonitored. For example, a Type-2 virtual measurement resource may include only one or more resources on which reference signaling is not transmitted and is not monitored (e.g., measured) by the UE. Thus, the UE may use an AI/ML model to predict a measurement value, or a CSI value derived from a measurement value, in each occasion of a Type 2 virtual measurement resource. In some aspects, a Type-2 virtual measurement resource may be connected with an actual measurement resource, as described in connection with FIG. 6.

The capabilities of a UE regarding measurement of actual measurement resources, and regarding prediction of measurement or CSI values for virtual measurement resources, may vary from UE to UE. For example, some UEs may be associated with separate and fixed allocations of hardware and/or software resources for the measurement of actual measurement resources and for the computation of predictions regarding virtual measurement resources. Other UEs may be associated with a shared and/or flexible allocation of hardware and/or software resources for the measurement of actual measurement resources and for the computation of predictions regarding virtual measurement resources. The capabilities of a UE regarding measurement of actual measurement resources, and regarding prediction of measurement or CSI values for virtual measurement resources, may affect how many measurement resources (e.g., CSI-RS resources or other forms of measurement resources) can be configured for and measured by the UE, as well as the distribution of such resources between virtual measurement resources and actual measurement resources. However, since different UEs can have different capabilities regarding these measurement resources, an approach where UEs are uniformly configured with a globally-specified number or configuration of virtual measurement resources and/or actual measurement resources may lead to situations where the capabilities of a UE are exceeded (leading to inaccurate or delayed predictions or failure to report CSI) or where the processing resources of a UE are inefficiently utilized (leading to failure to fully utilize measurement resources and shortcomings in CSI relative to a situation where the processing resources of the UE are efficiently utilized).

Some techniques provide signaling of capability information indicating a capability associated with virtual measurement resources (sometimes referred to as first measurement resources). The UE may transmit the capability information. The network node may receive the capability information. The UE may transmit, and the network node may receive, a CSI report based at least in part on the capability. By transmitting the capability information, the UE informs the network node of the UE's capability associated with the virtual measurement resources. This capability may enable the network node to avoid a configuration where the capabilities of the UE are exceeded, which reduces or eliminates the occurrence of inaccurate or delayed predictions or failure to report CSI relative to a situation where the network node is not aware of the UE's capabilities, thereby improving accuracy, timeliness, and utility of CSI. Furthermore, this capability may enable the network node to efficiently utilize the processing resources of the UE, which improves utilization of measurement resources relative to a situation where the network node is not aware of the UE's capabilities.

As indicated above, FIG. 7 is provided as an example. Other examples may differ from what is described with regard to FIG. 7.

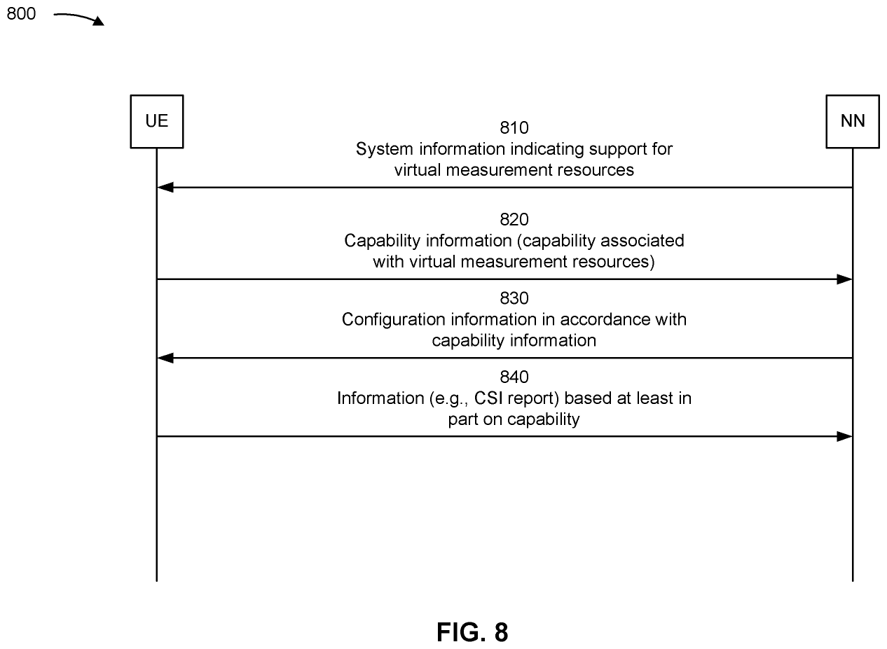

FIG. 8 is a diagram illustrating an example 800 of signaling for a capability regarding a virtual measurement resource, in accordance with the present disclosure. Example 800 includes a UE (e.g., UE 120) and a network node (e.g., network node 110). In some aspects, the network node may comprise multiple network nodes, such as a CU, a DU, and/or one or more RUs.

In some aspects, the UE may have separate computing resources (e.g., hardware and/or software computing resources) for measurement of actual measurement resources and for computation regarding virtual measurement resources. For example, a first set of computing resources may be used for measurement of actual measurement resources, and a second set of computing resources may be used for computation regarding virtual measurement resources. In some other aspects, the UE may have shared and/or flexible computing resources (e.g., hardware and/or software computing resources) for measurement of actual measurement resources and for computation regarding virtual measurement resources. For example, available resources of a single set of computing resources may be allocated to measurement of actual measurement resources (which may be referred to as conventional downlink reference signal measurements), or to computation regarding virtual measurement resources, according to the number or characteristics of actual measurement resources and/or virtual measurement resources configured for the UE.

As shown by reference number 810, in some aspects, the network node may optionally transmit, and the UE may optionally receive, system information prior to transmitting capability information. The system information may indicate that the network node supports usage (e.g., configuration or activation) of the virtual measurement resources. In some aspects, the UE may receive signaling other than system information indicating that the network node supports usage (e.g., configuration) of the virtual measurement resources, such as RRC signaling or the like. In some aspects, the system information (or other signaling) may indicate whether the network node supports virtual CMRs, virtual IMRs, or both. In some aspects, the system information (or other signaling) may indicate whether the network node supports virtual measurement resources on a particular band combination. In some aspects, the system information (or other signaling) may indicate a capability of the network node, such as a maximum number of configured or simultaneously activated virtual measurement resources (or ports). The UE may transmit capability information based at least in part on the system information (or other signaling) indicating that the network node supports usage of the virtual measurement resources.

As shown by reference number 820, the UE may transmit, and the network node may receive, capability information. The capability information may indicate one or more capabilities of the UE. For example, the capability information may include one or more capability information elements (IEs) that indicate one or more capabilities of the UE. The one or more capabilities may be associated with virtual measurement resources (sometimes referred to herein as “first measurement resources”). For example, the one or more capabilities may indicate a capability related to a number of virtual measurement resources that the UE is capable of processing or being configured with. As mentioned elsewhere herein, the virtual measurement resources may include logical resources for beam management and on which reference signaling is, at least partially, untransmitted and/or unmonitored. In some aspects, the reference signaling may be completely untransmitted and/or unmonitored (such as for Type-2 virtual measurement resources). In some other aspects, the reference signaling may be partially untransmitted and/or unmonitored (such as for Type-1 virtual measurement resources). The description of FIG. 8 refers to “a capability”, but it should be understood that the aspects described with regard to FIG. 8 can be applied for capability information indicating multiple capabilities (e.g., for each capability indicated by the capability information). The virtual measurement resources may be used by the UE to predict (e.g., identify) and/or report one or more CSI values (e.g., in a CSI report), such as an L1 RSRP, an L1 SINR, a rank indicator (RI, indicating a rank that can be supported by the channel), a CQI (indicating a modulation scheme and code rate that can be supported by the channel), a PMI (indicating a precoding matrix supportable by the channel), or a layer indicator (LI, indicating a strongest layer from the set of layers indicated by the RI), among other examples.

In some aspects, the capability is specific to a serving cell of the UE. For example, the capability information may be specific to a component carrier. For example, the capability information may include an indication of a serving cell to which the capability relates. As another example, the capability associated with the first management resources may apply to first management resources configured on the serving cell to which the capability is specific. As another example, the capability may relate to a serving cell on which the capability is transmitted. In some aspects, described elsewhere herein, the capability is specific to a group of serving cells or to all component carriers of the UE. In some aspects, described elsewhere herein, the capability is specific to a band combination. A serving cell is a carrier (e.g., a component carrier) on which data and/or control signaling of the UE is performed. The UE can use one or more serving cells, such as a primary cell, a secondary cell, and/or a primary secondary cell.

In some aspects, the capability is specific to all component carriers of a frequency range. For example, the capability may include a parameter (e.g., maxTotalVirtualResourcesForOneFreqRange) that indicates a maximum total number of configured virtual measurement resources or ports for all component carriers of a frequency range (e.g., FR1 or FR2, among other examples). As another example, the capability may include a parameter that indicates a scaling factor, applicable to a capability for an actual measurement resource, to derive a capability for a virtual measurement resource across all CCs of a frequency range, as described above. As yet another example, the capability may indicate a total maximum number of measurement resources supported for virtual measurement resources and for actual measurement resources across all CCs of a frequency range. Thus, the capability signaling described herein can be extended to cases where L1 measurement values, such as L1 SINR or L1 RSRP, are addressed as report quantities.

In some aspects, the capability is specific to multiple frequency ranges. For example, the capability may include a parameter (e.g., maxTotalVirtualResourcesForAcrossFreqRanges) that indicates a maximum total number of configured virtual measurement resources or ports across all CCs of all frequency ranges of the UE. As another example, the capability may include a parameter that indicates a scaling factor, applicable to a capability for an actual measurement resource, to derive a capability for a virtual measurement resource across all CCs of all frequency ranges of the UE, as described above. As yet another example, the capability may indicate a total maximum number of measurement resources supported for virtual measurement resources and for actual measurement resources across all CCs of all frequency ranges of the UE. Thus, the capability signaling described herein can be extended to cases where L1 measurement values, such as L1 SINR or L1 RSRP, are addressed as report quantities.

In some aspects, the capability may indicate at least one of a maximum number of configured virtual measurement resources or a maximum number of simultaneously active virtual measurement resources. A configured virtual measurement resource is a virtual measurement resource that has been configured for the UE (such as via RRC signaling). A configured virtual measurement resource may be counted for the purpose of the capability irrespective of whether the configured virtual measurement resource is active. Active virtual measurement resources are described in more detail below. Two resources may be considered to be simultaneously active if the two resources are active at the same time.

In some aspects, the capability information may explicitly indicate at least one of the maximum number of configured virtual measurement resources or the maximum number of simultaneously active virtual measurement resources. For example, the capability information may include a capability that identifies the maximum number of configured virtual measurement resources (e.g., the capability may indicate “4” corresponding to a maximum of 4 configured virtual measurement resources) or the maximum number of simultaneously active virtual measurement resources. For example, one or more parameters of the configuration parameters may indicate the maximum number of configured virtual measurement resources or the maximum number of simultaneously active virtual measurement resources. In some aspects, the one or more parameters may be provided in a parameter of capability information (e.g., virtual-Resource-MonitoringForFeedback). The one or more parameters may include a parameter indicating the maximum number of configured virtual measurement resources per CC (e.g., maxConfigNumberVirtual-Resource-PerCC), a parameter indicating indicates the maximum number of ports across all configured virtual measurement resources per CC (e.g., maxConfigNumberPortsAcrossVirtual-Resource-PerCC), a parameter indicating a maximum number of simultaneously active virtual measurement resources per CC (e.g., maxNumberSimultaneousVirtual-Resources-PerCC), a parameter indicating a maximum total number of virtual resource ports in simultaneous CSI-RS resources per CC (e.g., totalNumberPortsSimultaneousVirtual-Resource-PerCC), or a combination thereof. In this example, capabilities regarding virtual measurement resources may be separately reported from capabilities relating to actual measurement resources.

In some aspects, the UE may report separate capabilities for virtual CMRs and virtual IMRs. For example, the UE may report one or more parameters indicating capabilities (such as the one or more capabilities described above, a scaling factor, or the like) for CMRs (e.g., a parameter indicating the maximum number of configured virtual measurement resources per CC as CMRs, such as maxConfigNumberVirtual-Resource-CMR-PerCC, or a parameter indicating a scaling factor for determination of the maximum number of configured virtual measurement resources such as FactorBtwVirtualAndActualResources-CMR) and one or more parameters indicating capabilities (such as the one or more capabilities described above) for IMRs (e.g., a parameter indicating the maximum number of configured virtual resources per CC as IMRs, such as maxConfigNumberVirtual-Resource-IMR-PerCC, or a parameter indicating a scaling factor for determination of the maximum number of configured virtual measurement resources such as FactorBtwVirtualAndActualResources-IMR). In some aspects, the separate capabilities for virtual CMRs and virtual IMRs may be reported in addition to capabilities indicating at least one of the maximum number of configured virtual measurement resources or the maximum number of simultaneously active virtual measurement resources. In some other aspects, the capabilities indicating at least one of the maximum number of configured virtual measurement resources or the maximum number of simultaneously active virtual measurement resources may indicate separate capabilities for virtual CMRs and virtual IMRs. Thus, differences in complexity between processing of virtual CMRs and virtual IMRs can be accounted for in the capability information, which improves utilization of UE processing resources.

As mentioned, the capability may indicate a maximum number of simultaneously active virtual measurement resources. A virtual measurement resource can be periodic, aperiodic, or semi-persistent. An aperiodic virtual measurement resource may be considered active (for the purpose of counting the maximum number of simultaneously active virtual measurement resources) starting from an end of a PDCCH containing a request for the virtual measurement resource and ending at the end of a scheduled PUSCH containing a CSI report associated with the virtual measurement resource. A semi-persistent virtual measurement resource may be considered active starting from an end of when the activation command for the semi-persistent virtual measurement resource is applied, and ending at an end of when the deactivation command for the semi-persistent virtual measurement resource is applied. A periodic virtual measurement resource may be active starting when the periodic virtual measurement resource is configured by higher layer signaling, and ending when the periodic virtual measurement resource configuration is released. If a virtual measurement resource is referred to N times by one or more CSI reporting settings, the virtual measurement resource and the CSI-RS port(s) within the virtual measurement resource are counted N times for the purpose of determining a number of active resources.

In some aspects, the capability information indicates a scaling factor that can be used to determine a capability for a virtual measurement resource. The scaling factor may be applicable to a capability for an actual measurement resource. For example, the scaling factor may be applicable to a maximum number of configured actual measurement resources or a maximum number of simultaneously active actual measurement resources in order to derive a capability for a maximum number of configured virtual measurement resources or a maximum number of simultaneously active virtual measurement resources, respectively. In one example, the capability may include a parameter (e.g., FactorBtw VirtualAndActualResources) indicating the scaling factor. A maximum number of configured virtual measurement resources may be determined by combining a maximum number of configured actual measurement resources and the scaling factor (e.g., maxConfigNumberNZP-CSI-RS-PerCC×FactorBtwVirtualAndActualResources). A maximum number of ports across all configured virtual measurement resources may be determined by combining a maximum number of ports across all configured actual measurement resources and the scaling factor (e.g., maxConfigNumberPortsAcrossNZP-CSI-RS-PerCC×FactorBtwVirtualAndActualResources). A maximum number of simultaneously active virtual measurement resources may be determined by combining a maximum number of simultaneously active actual measurement resources and the scaling factor (e.g., maxNumberSimultaneousNZP-CSI-RS-PerCC×FactorBtwVirtualAndActualResources). A maximum total number of ports in simultaneously active virtual measurement resources may be determined by combining a maximum total number of ports in simultaneously active actual measurement resources and the scaling factor (e.g., totalNumberPortsSimultaneousNZP-CSI-RS-PerCC×actorBtwVirtualAndActualResources). A port may correspond to an RE. For example, a number of ports of a measurement resource may indicate a number of REs on which a reference signal is transmitted in the measurement resource. A port or a number of ports, in the context of a virtual measurement resource, may be used as an input to an AI/ML model used to determine a measurement value, CSI value, or the like, regarding the virtual measurement resource.

In some aspects, the capability information indicates one or more capabilities for actual measurement resources. For example, the capability information may indicate at least one of a maximum number of configured actual measurement resources, a maximum number of simultaneously active actual measurement resources, a maximum number of ports across all configured actual measurement resources, or a maximum number of ports across all simultaneously activated actual measurement resources. As another example, the capability information may indicate the maximum number of configured virtual measurement resources and actual measurement resources per CC (e.g., NZP-CSI-RS resources) (such as via a parameter maxConfigNumber-Resource-PerCC, which in some aspects may also indicate a number of transmitted SSB resources within the CC). As another example, the capability information may indicate the maximum number of ports across configured virtual measurement resources and configured actual measurement resources per CC (e.g., NZP-CSI-RS resources) (such as via a parameter maxConfigNumberPortsAcross-Resource-PerCC, which in some aspects may also indicate a number of transmitted SSB resources within the CC). As another example, the capability information may indicate a maximum number of simultaneously active virtual measurement resources and simultaneously active actual measurement resources (e.g., NZP-CSI-RS resources) per CC (such as via a parameter maxNumberSimultaneous-Resources-PerCC, which in some aspects may also indicate a number of transmitted SSB resources configured or indicated as CMRs for any active CSI report). As another example, the capability information may indicate a maximum total number of virtual measurement resource ports in simultaneously active virtual resources and in actual measurement resources (e.g., CSI-RS resources) per CC (such as via a parameter totalNumberPortsSimultaneous-Resource-PerCC, which in some aspects may also indicate a number of transmitted SSB resources within the CC).

In some aspects, the capability may indicate a total number of virtual measurement resources and actual measurement resources. In some aspects, the capability may indicate a ratio (e.g., a scaling factor) indicating a number of virtual measurement resources included in the total number of virtual measurement resources and actual measurement resources. Additionally, or alternatively, the ratio may be preconfigured, such as in a wireless communication specification. In some aspects, the network node may configure or activate a number of virtual measurement resources and actual measurement resources that satisfies (e.g., is lower than or equal to) the total number of virtual measurement resources and actual measurement resources indicated by the capability. For example, if a total number of configured or activated virtual measurement resources and configured or activated actual measurement resources satisfies the capability, a specific number of configured or active virtual measurement resources and a specific number of configured or active actual measurement resources may be arbitrarily selected by the network node, which improves flexibility of configuration of virtual measurement resources and actual measurement resources relative to separately signaling maxima for virtual measurement resources and actual measurement resources. In some aspects, the network node may configure or activate a number of virtual measurement resources and actual measurement resources that satisfies (e.g., is lower than or equal to) the total number of virtual measurement resources and actual measurement resources indicated by the capability, as well as the ratio. For example, the network node may configure or activate, at most, a maximum number of configured or activated virtual measurement resources in accordance with the ratio and the total number of virtual measurement resources and actual measurement resources indicated by the capability, and a sum of the number of configured or activated virtual measurement resources and a number of configured or activated actual measurement resources may satisfy (e.g., be lower than or equal to) the total number of virtual measurement resources and actual measurement resources indicated by the capability. Thus, differences in complexity between processing of virtual measurement resources and actual measurement resources at the UE can be taken into account, which improves utilization of UE processing resources relative to configuring a number of virtual or actual measurement resources irrespective of the differences in complexity.

In some aspects, the capability indicates at least one of a first number of virtual measurement resources, of the virtual measurement resources, that include at least one measurement resource on which reference signaling is transmitted, or a second number of virtual measurement resources, of the virtual measurement resources, that include only virtual measurement resources. For example, the capability (e.g., one or more of the capabilities described with regard to FIG. 8) may indicate separate capabilities for Type-1 virtual measurement resources and Type-2 virtual measurement resources, or may indicate a joint capability for Type-1 virtual measurement resources and Type-2 virtual measurement resources (e.g., a single maximum number of configured or simultaneously activated virtual measurement resources or ports). As another example, a capability (e.g., one or more of the capabilities described with regard to FIG. 8) may indicate a capability for Type-1 measurement resources. As yet another example, a capability (e.g., one or more of the capabilities described with regard to FIG. 8) may indicate a capability for Type-2 measurement resources. In some aspects, the capability indicates the first number of virtual measurement resources (e.g., Type-1 virtual measurement resources) and the second number of virtual measurement resources (e.g., type-2 virtual measurement resources) separately. For example, the capability information may include separate sets of explicit capabilities regarding Type-1 virtual measurement resources and Type-2 virtual measurement resources. As another example, the capability information may include a first scaling factor for Type-1 virtual measurement resources and a second scaling factor for Type-2 virtual measurement resources. In some aspects, the first scaling factor or the second scaling factor may be applied to a capability for an actual measurement resource, as described elsewhere herein. Thus, the UE can indicate separate capabilities for Type-1 virtual measurement resources and Type-2 virtual measurement resources, which provides for differences in complexity when performing beam prediction for Type-1 virtual measurement resources versus Type-2 virtual measurement resources (e.g., an AI/ML model such as an artificial neural network for a Type-1 virtual measurement resource may be smaller than an AI/ML model for a Type-2 virtual measurement resource). Joint reporting may be particularly beneficial for UEs having flexible and/or shared hardware or software for actual and virtual measurement resource computation, whereas separate reporting (such as explicit reporting or implicit reporting using a scaling factor, described above) may be beneficial for UEs having fixed and separate hardware or software for actual and virtual measurement resource computation.

In some aspects, the capability information, or an earlier transmission of capability information by the UE, may indicate whether the UE supports virtual measurement resources. For example, the UE may provide an indication (e.g., a binary indication) of whether the UE supports configuration or activation of virtual measurement resources. In some aspects, the indication of whether the UE supports virtual measurement resources is specific to a band combination, a serving cell, a component carrier, or a group of component carriers. For example, the indication may indicate a band combination, a serving cell, a component carrier, or a group of component carriers to which the indication applies. The UE may subsequently provide capabilities for the band combination, the serving cell, the component carrier, or the group of component carriers, as described above.

In some aspects, the capability may indicate at least one of a total maximum number of configured virtual measurement resources (or ports), a total maximum number of simultaneously active virtual measurement resources (or ports), or a scaling factor for an actual measurement resource regarding multiple CCs of the UE (e.g., as an alternative to a per-serving-cell or a per-CC capability described above). For example, the capability may be specific to a group of CCs. As another example, the capability may be specific to all active CCs of the UE.

In some aspects, the capability may indicate at least one of a total maximum number of configured virtual measurement resources (or ports), a total maximum number of simultaneously active virtual measurement resources (or ports), or a scaling factor for an actual measurement resource, for a band combination (e.g., in addition to or as an alternative to a per-serving-cell or a per-CC capability described above). For example, a capability (which may or may not be a per-serving-cell capability) may indicate a band combination to which the capability relates.

As shown by reference number 830, the network node may output configuration information in accordance with the capability information. For example, the network node may generate the configuration information, or may provide the configuration information as received from another network node. The configuration information may configure one or more virtual measurement resources (e.g., Type-1 virtual measurement resources, Type-2 virtual measurement resources, or a combination thereof such as a Type-1 virtual measurement resource and a Type-2 virtual measurement resource), one or more actual measurement resources, or a combination thereof such as one or more virtual measurement resources and one or more actual measurement resources. Additionally, or alternatively, the configuration information may configure a CSI reporting setting indicating to transmit information based at least in part on the configured one or more virtual measurement resources and/or the one or more actual measurement resources.

The configuration information may configure the one or more virtual measurement resources or one or more actual measurement resources in accordance with the capability information. For example, the configuration information may configure a number of virtual measurement resources or ports that does not exceed a maximum number of virtual measurement resources or ports indicated by the capability information (e.g., an explicit indication, a ratio or scaling factor, etc.). As another example, the configuration information may configure a number of Type-1 virtual measurement resources or ports, and/or a number of Type-2 measurement resources or ports, that does not exceed a maximum number of Type-1 or Type-2 measurement resources or ports indicated by the capability information. As yet another example, the configuration information may configure a number of virtual CMRs or ports and/or a number of virtual IMRs that does not exceed a maximum number of virtual CMRs or ports or a number of virtual IMRs or ports indicated by the capability information.

As shown by reference number 840, the UE may transmit, and the network node may obtain (e.g., receive from the UE or from another network node) information based at least in part on the capability. For example, the UE may transmit a CSI report, one or more measurement values, one or more CSI values (e.g., an L1 RSRP, an L1SINR, a RI, a CQI, a PMI, or an LI), or the like. The transmitted information may be based at least in part on the capability. For example, the transmitted information may be determined in accordance with configuration information that is derived from the capability (e.g., the configuration information may configure virtual measurement resources and/or actual measurement resources in a fashion that does not exceed the capability). In some aspects, the transmitted information may relate to a virtual measurement resource. For example, the UE may compute the information (e.g., a measurement value, a CSI value, a CSI report) using an AI/ML model with regard to a configured (and/or activated) virtual measurement resource. Additionally, or alternatively, the transmitted information may relate to an actual measurement resource. For example, the UE may compute the information by performing a measurement on an actual measurement resource.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with a capability for virtual measurement resources for beam management.

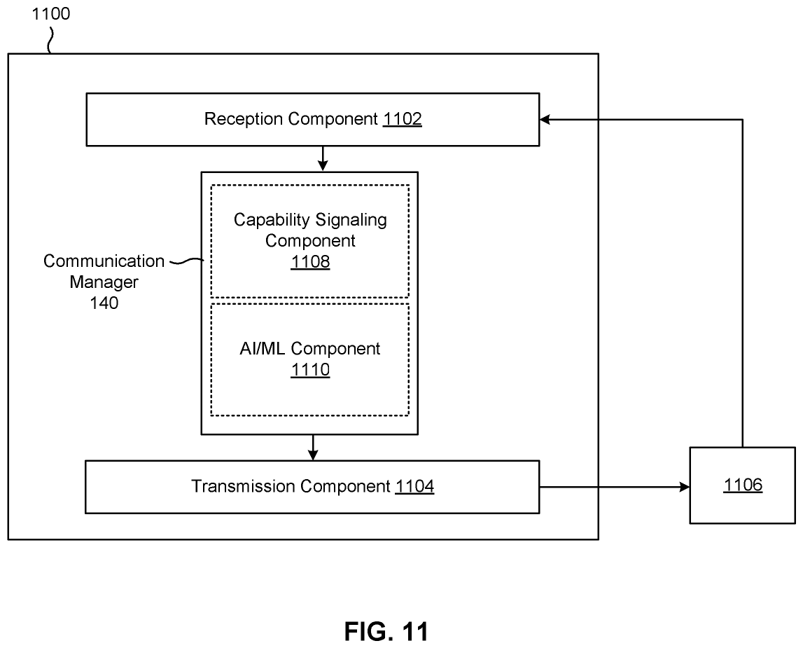

As shown in FIG. 9, in some aspects, process 900 may include transmitting capability information indicating a capability associated with first measurement resources, the first measurement resources comprising logical resources for beam management and on which reference signaling is, at least partially, unmonitored (block 910). For example, the UE (e.g., using communication manager 140 and/or capability signaling component 1108, depicted in FIG. 11) may transmit capability information indicating a capability associated with first measurement resources, the first measurement resources comprising logical resources for beam management and on which reference signaling is, at least partially, unmonitored (e.g., unreceived, unused, unmeasured), as described above.

As further shown in FIG. 9, in some aspects, process 900 may include transmitting a CSI report based at least in part on the capability (block 920). For example, the UE (e.g., using communication manager 140 and/or transmission component 1104, depicted in FIG. 11) may transmit a CSI report based at least in part on the capability, as described above.

Process 900 may include additional aspects, such as any single aspect or any combination of aspects described below and/or in connection with one or more other processes described elsewhere herein.

In a first aspect, the capability is specific to a component carrier.

In a second aspect, alone or in combination with the first aspect, the capability indicates at least one of a maximum number of configured first measurement resources or a maximum number of simultaneously active first measurement resources.

In a third aspect, alone or in combination with one or more of the first and second aspects, the capability information explicitly indicates the capability, wherein the capability indicates at least one of the maximum number of configured first measurement resources or the maximum number of simultaneously active first measurement resources.

In a fourth aspect, alone or in combination with one or more of the first through third aspects, the capability indicates at least one of the maximum number of configured first measurement resources or the maximum number of simultaneously active first measurement resources using a scaling factor for a maximum number of configured second measurement resources or a maximum number of simultaneously active second measurement resources.

In a fifth aspect, alone or in combination with one or more of the first through fourth aspects, a second measurement resource, of the configured second measurement resources or the simultaneously active second measurement resources, is a resource for beam management on which reference signaling is transmitted.

In a sixth aspect, alone or in combination with one or more of the first through fifth aspects, the capability further indicates at least one of a maximum number of configured second measurement resources, a maximum number of simultaneously active second measurement resources, a maximum number of ports across all configured second measurement resources, or a maximum number of ports across all simultaneously activated second measurement resources.

In a seventh aspect, alone or in combination with one or more of the first through sixth aspects, the capability indicates a total number of first measurement resources and second measurement resources.

In an eighth aspect, alone or in combination with one or more of the first through seventh aspects, the capability indicates a ratio indicating a number of first measurement resources included in the total number of first measurement resources and second measurement resources.

In a ninth aspect, alone or in combination with one or more of the first through eighth aspects, the capability further indicates a number of transmitted synchronization signal block resources within a component carrier to which the capability relates.

In a tenth aspect, alone or in combination with one or more of the first through ninth aspects, the capability further indicates a number of synchronization signal block resources indicated as channel measurement resources for any active CSI report at the UE.

In an eleventh aspect, alone or in combination with one or more of the first through tenth aspects, the capability information explicitly indicates the capability, wherein the capability indicates at least one of the maximum number of ports across all configured first measurement resources or the maximum number of ports across all simultaneously activated first measurement resources.

In a twelfth aspect, alone or in combination with one or more of the first through eleventh aspects, the capability indicates at least one of the maximum number of ports across all configured first measurement resources or the maximum number of ports across all simultaneously activated first measurement resources using a scaling factor.

In a thirteenth aspect, alone or in combination with one or more of the first through twelfth aspects, a first measurement resource of the first measurement resources comprises a virtual measurement resource on which reference signaling is not transmitted and another measurement resource on which reference signaling is transmitted.

In a fourteenth aspect, alone or in combination with one or more of the first through thirteenth aspects, a first measurement resource of the first measurement resources comprises only one or more virtual measurement resources on which reference signaling is not transmitted.

In a fifteenth aspect, alone or in combination with one or more of the first through fourteenth aspects, the first measurement resources comprise at least one of one or more channel measurement resources, one or more interference measurement resources, or a combination thereof.

In a sixteenth aspect, alone or in combination with one or more of the first through fifteenth aspects, the capability indicates at least one of a maximum number of ports across all configured first measurement resources or a maximum number of ports across all simultaneously activated first measurement resources.

In a seventeenth aspect, alone or in combination with one or more of the first through sixteenth aspects, the capability indicates at least one of a first number of first measurement resources, of the first measurement resources, that include at least one measurement resource on which reference signaling is transmitted, or a second number of first measurement resources, of the first measurement resources, that include only virtual measurement resources.

In an eighteenth aspect, alone or in combination with one or more of the first through seventeenth aspects, the capability indicates the first number of first measurement resources and the second number of first measurement resources separately.

In a nineteenth aspect, alone or in combination with one or more of the first through eighteenth aspects, the capability information is second capability information and the method further comprises transmitting first capability information indicating whether the UE supports usage of logical resources for beam management on which reference signaling is, at least partially, not transmitted.

In a twentieth aspect, alone or in combination with one or more of the first through nineteenth aspects, the first capability information is specific to a band combination, a component carrier, or a group of component carriers.

In a twenty-first aspect, alone or in combination with one or more of the first through twentieth aspects, the capability indicates at least one of a total maximum number of configured first measurement resources or a total maximum number of simultaneously active first measurement resources across all component carriers of the UE.

In a twenty-second aspect, alone or in combination with one or more of the first through twenty-first aspects, the capability indicates at least one of a total maximum number of configured first measurement resources or a total maximum number of simultaneously active first measurement resources for a band combination.

In a twenty-third aspect, alone or in combination with one or more of the first through twenty-second aspects, process 900 includes transmitting the capability information based at least in part on the system information.

In a twenty-fourth aspect, alone or in combination with one or more of the first through twenty-third aspects, the capability is specific to all component carriers of a frequency range.

In a twenty-fifth aspect, alone or in combination with one or more of the first through twenty-fourth aspects, the capability is specific to multiple frequency ranges.

In a twenty-sixth aspect, alone or in combination with one or more of the first through twenty-fifth aspects, the CSI report indicates at least one of a rank indicator, a layer indicator, a Layer 1 measurement value, a channel quality indicator, or a precoding matrix indicator.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with capability for logical resources for beam management.

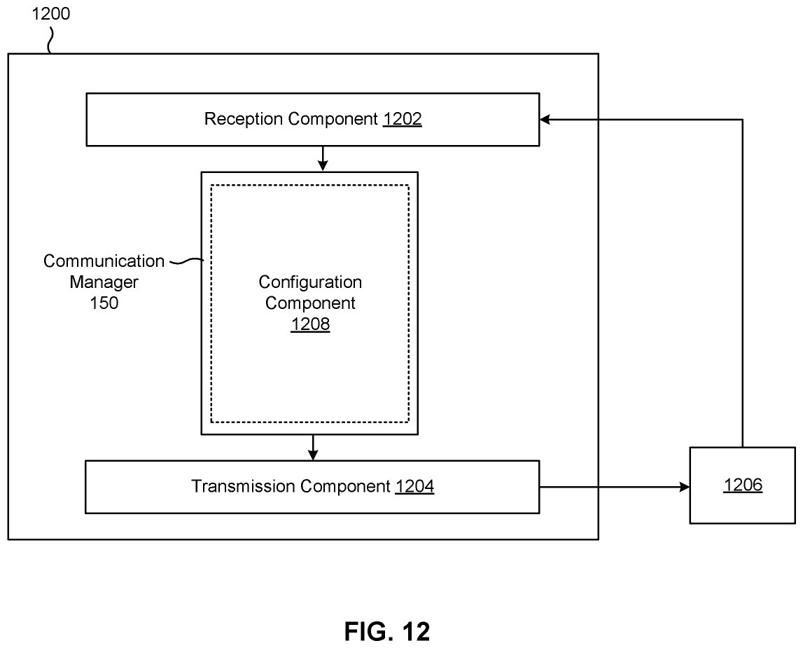

As shown in FIG. 10, in some aspects, process 1000 may include obtaining, from a UE, capability information indicating a capability associated with first measurement resources, the first measurement resources comprising logical resources for beam management and on which reference signaling is, at least partially, untransmitted (block 1010). For example, the network node (e.g., using communication manager 150 and/or reception component 1202, depicted in FIG. 12) may obtain, from a UE, capability information indicating a capability associated with first measurement resources, the first measurement resources comprising logical resources for beam management and on which reference signaling is, at least partially, untransmitted, as described above.

As further shown in FIG. 10, in some aspects, process 1000 may include outputting configuration information configuring one or more first measurement resources in accordance with the capability (block 1020). For example, the network node (e.g., using communication manager 150 and/or configuration component 1208, depicted in FIG. 12) may output configuration information configuring one or more first measurement resources in accordance with the capability, as described above.

Process 1000 may include additional aspects, such as any single aspect or any combination of aspects described below and/or in connection with one or more other processes described elsewhere herein.

In a first aspect, the capability is specific to a component carrier.

In a second aspect, alone or in combination with the first aspect, the capability indicates at least one of a maximum number of configured first measurement resources or a maximum number of simultaneously active first measurement resources.

In a third aspect, alone or in combination with one or more of the first and second aspects, the capability information explicitly indicates the capability, wherein the capability indicates at least one of the maximum number of configured first measurement resources or the maximum number of simultaneously active first measurement resources.

In a fourth aspect, alone or in combination with one or more of the first through third aspects, the capability indicates at least one of the maximum number of configured first measurement resources or the maximum number of simultaneously active first measurement resources using a scaling factor for a maximum number of configured second measurement resources or a maximum number of simultaneously active second measurement resources.

In a fifth aspect, alone or in combination with one or more of the first through fourth aspects, a second measurement resource, of the configured second measurement resources or the simultaneously active second measurement resources, is a resource for beam management on which reference signaling is transmitted.

In a sixth aspect, alone or in combination with one or more of the first through fifth aspects, the capability further indicates at least one of a maximum number of configured second measurement resources, a maximum number of simultaneously active second measurement resources, a maximum number of ports across all configured second measurement resources, or a maximum number of ports across all simultaneously activated second measurement resources.

In a seventh aspect, alone or in combination with one or more of the first through sixth aspects, the capability indicates a total number of first measurement resources and second measurement resources.

In an eighth aspect, alone or in combination with one or more of the first through seventh aspects, the capability indicates a ratio indicating a number of first measurement resources included in the total number of first measurement resources and second measurement resources.

In a ninth aspect, alone or in combination with one or more of the first through eighth aspects, the capability further indicates a number of transmitted synchronization signal block resources within a component carrier to which the capability relates.

In a tenth aspect, alone or in combination with one or more of the first through ninth aspects, the capability further indicates a number of synchronization signal block resources indicated as channel measurement resources for any active CSI report at the UE.

In an eleventh aspect, alone or in combination with one or more of the first through tenth aspects, the capability information explicitly indicates the capability, wherein the capability indicates at least one of the maximum number of ports across all configured first measurement resources or the maximum number of ports across all simultaneously activated first measurement resources.

In a twelfth aspect, alone or in combination with one or more of the first through eleventh aspects, the capability indicates at least one of the maximum number of ports across all configured first measurement resources or the maximum number of ports across all simultaneously activated first measurement resources using a scaling factor.

In a thirteenth aspect, alone or in combination with one or more of the first through twelfth aspects, a first measurement resource of the first measurement resources comprises a virtual measurement resource on which reference signaling is not transmitted and another measurement resource on which reference signaling is transmitted.

In a fourteenth aspect, alone or in combination with one or more of the first through thirteenth aspects, the first measurement resources comprise at least one of one or more channel measurement resources, one or more interference measurement resources, or a combination thereof.

In a fifteenth aspect, alone or in combination with one or more of the first through fourteenth aspects, the capability indicates at least one of a maximum number of ports across all configured first measurement resources or a maximum number of ports across all simultaneously activated first measurement resources.

In a sixteenth aspect, alone or in combination with one or more of the first through fifteenth aspects, the capability indicates at least one of a first number of first measurement resources, of the first measurement resources, that include at least one measurement resource on which reference signaling is transmitted, or a second number of first measurement resources, of the first measurement resources, that include only virtual measurement resources.

In a seventeenth aspect, alone or in combination with one or more of the first through sixteenth aspects, the capability indicates the first number of first measurement resources and the second number of first measurement resources separately.

In an eighteenth aspect, alone or in combination with one or more of the first through seventeenth aspects, the capability information is second capability information and the method further comprises obtaining first capability information indicating whether the UE supports usage of logical resources for beam management on which reference signaling is, at least partially, not transmitted.

In a nineteenth aspect, alone or in combination with one or more of the first through eighteenth aspects, the first capability information is specific to a band combination, a component carrier, or a group of component carriers.

In a twentieth aspect, alone or in combination with one or more of the first through nineteenth aspects, the capability indicates at least one of a total maximum number of configured first measurement resources or a total maximum number of simultaneously active first measurement resources across all component carriers of the UE.

In a twenty-first aspect, alone or in combination with one or more of the first through twentieth aspects, the capability indicates at least one of a total maximum number of configured first measurement resources or a total maximum number of simultaneously active first measurement resources for a band combination.

In a twenty-second aspect, alone or in combination with one or more of the first through twenty-first aspects, process 1000 includes obtaining the capability information based at least in part on the system information.

In a twenty-third aspect, alone or in combination with one or more of the first through twenty-second aspects, the capability is specific to all component carriers of a frequency range.

In a twenty-fourth aspect, alone or in combination with one or more of the first through twenty-third aspects, the capability is specific to multiple frequency ranges.

In a twenty-fifth aspect, alone or in combination with one or more of the first through twenty-fourth aspects, process 1000 includes receiving, based at least in part on the configuration information, a CSI report indicating at least one of a rank indicator, a layer indicator, a Layer 1 measurement value, a channel quality indicator, or a precoding matrix indicator.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a capability signaling component 1108 or an AI/ML component 1110, among other examples.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The transmission component 1104 may transmit capability information indicating a capability associated with first measurement resources, the first measurement resources comprising logical resources for beam management and on which reference signaling is, at least partially, unmonitored. The transmission component 1104 may transmit a CSI report based at least in part on the capability.

The transmission component 1104 may transmit the capability information based at least in part on the system information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The reception component 1202 may obtain, from a UE, capability information indicating a capability associated with first measurement resources, the first measurement resources comprising logical resources for beam management and on which reference signaling is, at least partially, untransmitted. The transmission component 1204 or the configuration component 1208 may output configuration information configuring one or more first measurement resources in accordance with the capability.

The reception component 1202 may obtain the capability information based at least in part on the system information.

The reception component 1202 may receive, based at least in part on the configuration information, a CSI report indicating at least one of a rank indicator, a layer indicator, a Layer 1 measurement value, a channel quality indicator, or a precoding matrix indicator.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: transmitting capability information indicating a capability associated with first measurement resources, the first measurement resources comprising logical resources for beam management and on which reference signaling is, at least partially, unmonitored; and transmitting a channel state information (CSI) report based at least in part on the capability.
Aspect 2: The method of Aspect 1, wherein the capability is specific to a serving cell.
Aspect 3: The method of any of Aspects 1-2, wherein the capability indicates at least one of a maximum number of configured first measurement resources or a maximum number of simultaneously active first measurement resources.
Aspect 4: The method of Aspect 3, wherein the capability information explicitly indicates the capability, wherein the capability indicates at least one of the maximum number of configured first measurement resources or the maximum number of simultaneously active first measurement resources.
Aspect 5: The method of Aspect 3, wherein the capability information indicates a scaling factor applicable to at least one of a maximum number of configured second measurement resources or a maximum number of simultaneously active second measurement resources, wherein at least one of the maximum number of configured first measurement resources or the maximum number of simultaneously active first measurement resources is based at least in part on the scaling factor.
Aspect 6: The method of Aspect 5, wherein a second measurement resource, of the configured second measurement resources or the simultaneously active second measurement resources, is a resource for beam management on which reference signaling is transmitted.
Aspect 7: The method of Aspect 3, wherein the capability further indicates at least one of a maximum number of configured second measurement resources, a maximum number of simultaneously active second measurement resources, a maximum number of ports across all configured second measurement resources, or a maximum number of ports across all simultaneously activated second measurement resources.
Aspect 8: The method of Aspect 7, wherein the capability indicates a total number of first measurement resources and second measurement resources.
Aspect 9: The method of Aspect 8, wherein the capability indicates a ratio indicating a number of first measurement resources included in the total number of first measurement resources and second measurement resources.
Aspect 10: The method of Aspect 3, wherein the capability further indicates a number of transmitted synchronization signal block resources within a component carrier to which the capability relates.
Aspect 11: The method of Aspect 3, wherein the capability further indicates a number of synchronization signal block resources indicated as channel measurement resources for any active CSI report at the UE.
Aspect 12: The method of Aspect 11, wherein the capability information explicitly indicates the capability, wherein the capability indicates at least one of the maximum number of ports across all configured first measurement resources or the maximum number of ports across all simultaneously activated first measurement resources.
Aspect 13: The method of Aspect 11, wherein the capability indicates at least one of the maximum number of ports across all configured first measurement resources or the maximum number of ports across all simultaneously activated first measurement resources using a scaling factor.
Aspect 14: The method of any of Aspects 1-13, wherein a first measurement resource of the first measurement resources comprises a virtual measurement resource on which reference signaling is not transmitted and another measurement resource on which reference signaling is transmitted.
Aspect 15: The method of any of Aspects 1-14, wherein a first measurement resource of the first measurement resources comprises only one or more virtual measurement resources on which reference signaling is not transmitted.
Aspect 16: The method of any of Aspects 1-15, wherein the first measurement resources comprise at least one of: one or more channel measurement resources, one or more interference measurement resources, or a combination thereof.
Aspect 17: The method of any of Aspects 1-16, wherein the capability indicates at least one of a maximum number of ports across all configured first measurement resources or a maximum number of ports across all simultaneously activated first measurement resources.
Aspect 18: The method of any of Aspects 1-17, wherein the capability indicates at least one of a first number of first measurement resources, of the first measurement resources, that include at least one measurement resource on which reference signaling is transmitted, or a second number of first measurement resources, of the first measurement resources, that include only virtual measurement resources.
Aspect 19: The method of Aspect 18, wherein the capability indicates the first number of first measurement resources and the second number of first measurement resources separately.
Aspect 20: The method of any of Aspects 1-19, wherein the capability information is second capability information and the method further comprises transmitting first capability information indicating whether the UE supports usage of logical resources for beam management on which reference signaling is, at least partially, not transmitted.
Aspect 21: The method of Aspect 20, wherein the first capability information is specific to a band combination, a component carrier, or a group of component carriers.
Aspect 22: The method of any of Aspects 1-21, wherein the capability indicates at least one of a total maximum number of configured first measurement resources or a total maximum number of simultaneously active first measurement resources across all component carriers of the UE.
Aspect 23: The method of any of Aspects 1-22, wherein the capability indicates at least one of a total maximum number of configured first measurement resources or a total maximum number of simultaneously active first measurement resources for a band combination.
Aspect 24: The method of any of Aspects 1-23, further comprising receiving system information prior to transmitting the capability information, wherein the system information indicates that a network node supports usage of the first measurement resources, and wherein transmitting the capability information further comprises transmitting the capability information based at least in part on the system information.
Aspect 25: The method of any of Aspects 1-24, wherein the capability is specific to all component carriers of a frequency range.
Aspect 26: The method of any of Aspects 1-24, wherein the capability is specific to multiple frequency ranges.
Aspect 27: The method of any of Aspects 1-26, wherein the CSI report indicates at least one of: a rank indicator, a layer indicator, a Layer 1 measurement value, a channel quality indicator, or a precoding matrix indicator.
Aspect 28: A method of wireless communication performed by a network node, comprising: obtaining, from a user equipment (UE), capability information indicating a capability associated with first measurement resources, the first measurement resources comprising logical resources for beam management and on which reference signaling is, at least partially, untransmitted; and outputting configuration information configuring one or more first measurement resources in accordance with the capability.
Aspect 29: The method of Aspect 28, wherein the capability is specific to a component carrier.
Aspect 30: The method of any of Aspects 28-29, wherein the capability indicates at least one of a maximum number of configured first measurement resources or a maximum number of simultaneously active first measurement resources.
Aspect 31: The method of Aspect 30, wherein the capability information explicitly indicates the capability, wherein the capability indicates at least one of the maximum number of configured first measurement resources or the maximum number of simultaneously active first measurement resources.
Aspect 32: The method of Aspect 30, wherein the capability information indicates a scaling factor applicable to at least one of a maximum number of configured second measurement resources or a maximum number of simultaneously active second measurement resources, wherein at least one of the maximum number of configured first measurement resources or the maximum number of simultaneously active first measurement resources is based at least in part on the scaling factor.
Aspect 33: The method of Aspect 32, wherein a second measurement resource, of the configured second measurement resources or the simultaneously active second measurement resources, is a resource for beam management on which reference signaling is transmitted.
Aspect 34: The method of Aspect 30, wherein the capability further indicates at least one of a maximum number of configured second measurement resources, a maximum number of simultaneously active second measurement resources, a maximum number of ports across all configured second measurement resources, or a maximum number of ports across all simultaneously activated second measurement resources.
Aspect 35: The method of Aspect 34, wherein the capability indicates a total number of first measurement resources and second measurement resources.
Aspect 36: The method of Aspect 35, wherein the capability indicates a ratio indicating a number of first measurement resources included in the total number of first measurement resources and second measurement resources.
Aspect 37: The method of Aspect 30, wherein the capability further indicates a number of transmitted synchronization signal block resources within a component carrier to which the capability relates.
Aspect 38: The method of Aspect 30, wherein the capability further indicates a number of synchronization signal block resources indicated as channel measurement resources for any active CSI report at the UE.
Aspect 39: The method of Aspect 38, wherein the capability information explicitly indicates the capability, wherein the capability indicates at least one of the maximum number of ports across all configured first measurement resources or the maximum number of ports across all simultaneously activated first measurement resources.
Aspect 40: The method of Aspect 38, wherein the capability indicates at least one of the maximum number of ports across all configured first measurement resources or the maximum number of ports across all simultaneously activated first measurement resources using a scaling factor.
Aspect 41: The method of Aspect 30, wherein a first measurement resource of the first measurement resources comprises a virtual measurement resource on which reference signaling is not transmitted and another measurement resource on which reference signaling is transmitted.
Aspect 42: The method of any of Aspects 28-41, wherein a first measurement resource of the first measurement resources comprises only one or more virtual measurement resources on which reference signaling is not transmitted.
Aspect 43: The method of any of Aspects 28-42, wherein the first measurement resources comprise at least one of: one or more channel measurement resources, one or more interference measurement resources, or a combination thereof.
Aspect 44: The method of any of Aspects 28-43, wherein the capability indicates at least one of a maximum number of ports across all configured first measurement resources or a maximum number of ports across all simultaneously activated first measurement resources.
Aspect 45: The method of any of Aspects 28-44, wherein the capability indicates at least one of a first number of first measurement resources, of the first measurement resources, that include at least one measurement resource on which reference signaling is transmitted, or a second number of first measurement resources, of the first measurement resources, that include only virtual measurement resources.
Aspect 46: The method of Aspect 45, wherein the capability indicates the first number of first measurement resources and the second number of first measurement resources separately.
Aspect 47: The method of any of Aspects 28-46, wherein the capability information is second capability information and the method further comprises obtaining first capability information indicating whether the UE supports usage of logical resources for beam management on which reference signaling is, at least partially, not transmitted.
Aspect 48: The method of Aspect 47, wherein the first capability information is specific to a band combination, a component carrier, or a group of component carriers.
Aspect 49: The method of any of Aspects 28-48, wherein the capability indicates at least one of a total maximum number of configured first measurement resources or a total maximum number of simultaneously active first measurement resources across all component carriers of the UE.
Aspect 50: The method of any of Aspects 28-49, wherein the capability indicates at least one of a total maximum number of configured first measurement resources or a total maximum number of simultaneously active first measurement resources for a band combination.
Aspect 51: The method of any of Aspects 28-50, further comprising outputting system information prior to the capability information, wherein the system information indicates that the network node supports usage of the first measurement resources, and wherein obtaining the capability information further comprises obtaining the capability information based at least in part on the system information.
Aspect 52: The method of any of Aspects 28-51, wherein the capability is specific to all component carriers of a frequency range.
Aspect 53: The method of any of Aspects 28-52, wherein the capability is specific to multiple frequency ranges.
Aspect 54: The method of any of Aspects 28-53, further comprising receiving, based at least in part on the configuration information, a CSI report indicating at least one of: a rank indicator, a layer indicator, a Layer 1 measurement value, a channel quality indicator, or a precoding matrix indicator.
Aspect 55: An apparatus for wireless communication at a device, comprising a processor; memory coupled with the processor; and instructions stored in the memory and executable by the processor to cause the apparatus to perform the method of one or more of Aspects 1-54.
Aspect 56: A device for wireless communication, comprising a memory and one or more processors coupled to the memory, the one or more processors configured to perform the method of one or more of Aspects 1-54.
Aspect 57: An apparatus for wireless communication, comprising at least one means for performing the method of one or more of Aspects 1-54.
Aspect 58: A non-transitory computer-readable medium storing code for wireless communication, the code comprising instructions executable by a processor to perform the method of one or more of Aspects 1-54.
Aspect 59: A non-transitory computer-readable medium storing a set of instructions for wireless communication, the set of instructions comprising one or more instructions that, when executed by one or more processors of a device, cause the device to perform the method of one or more of Aspects 1-54.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one”or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either”or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination.

Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A user equipment (UE) for wireless communication, comprising:
a memory; and
one or more processors, coupled to the memory, configured to:
transmit capability information indicating a capability associated with first measurement resources, the first measurement resources comprising logical resources for beam management and on which reference signaling is, at least partially, unmonitored; and
transmit a channel state information (CSI) report based at least in part on the capability.

2. The UE of claim 1, wherein the capability is specific to a serving cell.

3. The UE of claim 1, wherein the capability indicates at least one of a maximum number of configured first measurement resources or a maximum number of simultaneously active first measurement resources.

4. The UE of claim 3, wherein the capability information explicitly indicates the capability, wherein the capability indicates at least one of the maximum number of configured first measurement resources or the maximum number of simultaneously active first measurement resources.

5. The UE of claim 3, wherein the capability information indicates a scaling factor applicable to at least one of a maximum number of configured second measurement resources or a maximum number of simultaneously active second measurement resources, wherein at least one of the maximum number of configured first measurement resources or the maximum number of simultaneously active first measurement resources is based at least in part on the scaling factor.

6. The UE of claim 5, wherein a second measurement resource, of the configured second measurement resources or the simultaneously active second measurement resources, is a resource for beam management on which reference signaling is transmitted.

7. The UE of claim 3, wherein the capability further indicates at least one of a maximum number of configured second measurement resources, a maximum number of simultaneously active second measurement resources, a maximum number of ports across all configured second measurement resources, or a maximum number of ports across all simultaneously activated second measurement resources.

8. The UE of claim 7, wherein the capability indicates a total number of first measurement resources and second measurement resources.

9. The UE of claim 8, wherein the capability indicates a ratio indicating a number of first measurement resources included in the total number of first measurement resources and second measurement resources.

10. The UE of claim 3, wherein the capability further indicates a number of transmitted synchronization signal block resources within a component carrier to which the capability relates.

11. The UE of claim 3, wherein the capability further indicates a number of synchronization signal block resources indicated as channel measurement resources for any active CSI report at the UE.

12. The UE of claim 11, wherein the capability information explicitly indicates the capability, wherein the capability indicates at least one of a maximum number of ports across all configured first measurement resources or a maximum number of ports across all simultaneously activated first measurement resources.

13. The UE of claim 11, wherein the capability indicates at least one of a maximum number of ports across all configured first measurement resources or a maximum number of ports across all simultaneously activated first measurement resources based at least in part on a scaling factor.

14. The UE of claim 1, wherein the first measurement resources comprise at least one of:
one or more channel measurement resources,
one or more interference measurement resources, or
a combination thereof.

15. The UE of claim 1, wherein the one or more processors are further configured to receive system information prior to transmitting the capability information, wherein the system information indicates that a network node supports usage of the first measurement resources, and wherein the one or more processors, to transmit the capability information, are further configured to transmit the capability information based at least in part on the system information.

16. A network node for wireless communication, comprising:
a memory; and
one or more processors, coupled to the memory, configured to:
obtain, from a user equipment (UE), capability information indicating a capability associated with first measurement resources, the first measurement resources comprising logical resources for beam management and on which reference signaling is, at least partially, untransmitted; and
output configuration information configuring one or more first measurement resources in accordance with the capability.

17. The network node of claim 16, wherein the capability is specific to a serving cell.

18. The network node of claim 16, wherein the capability indicates at least one of a maximum number of configured first measurement resources or a maximum number of simultaneously active first measurement resources.

19. The network node of claim 16, wherein a first measurement resource of the first measurement resources comprises only one or more virtual measurement resources on which reference signaling is not transmitted.

20.-26. (canceled)

27. A method of wireless communication performed by a user equipment (UE), comprising:
transmitting capability information indicating a capability associated with first measurement resources, the first measurement resources comprising logical resources for beam management and on which reference signaling is, at least partially, unmonitored; and
transmitting a channel state information (CSI) report based at least in part on the capability.

28.-30. (canceled)
